(19) United States
(12) Patent Application Publication
(10) Pub. No.: US 2008/0057889 A1
(43) Pub. Date: Mar. 6, 2008

(54) Integrated portable wireless transmitter and method for use

(76) Inventor: Jonathan Jan, Culver City, CA (US)

Correspondence Address: Jonathan Jan, 4611 Coolidge Ave., Culver City, CA, 90230, US

(21) Appl. No.: 11/512,875

(22) Filed: Aug. 30, 2006

(51) Int. Cl. H04B 1/18

(52) U.S. Cl. 455/185.1

(57) ABSTRACT

The present invention is a cell phone holder and transmitter that is compact in size and is small and light in weight whereby it is capable of being clipped onto a holder attachment in a vehicle by a mounting clip and a gooseneck with affixed clip at the end. The holder of the cell phone itself also acts as the transmitter thereby minimizing the size and dimensions of the present invention. The present invention is capable of transmitting from an MP3 device, I-Pod or other media player. The present invention is also compatible with other devices utilizing a standard 3.5 mm audio output source. The present invention utilizes mounting surfaces composed of silicon rubber embedded in fluoride. Said combination of materials allows the formation of a secure seal for a cell phone while resting within the present invention and said material additionally allows a user to place and remove a cell phone of varying dimensions with minimum effort. A co-axial microphone wire cable of the present invention serves as a Frequency Modulation (FM) transmitter antenna. Said speaker and microphone wire cable antenna is composed of a copper alloy material to further its utility as an antenna. Said Transmitter sends signals to the FM band. Said FM band transmission is of a frequency at or between 88.1 and 88.9. Said present invention operates on less than 1 watt of output.

### BACKGROUND OF THE INVENTION

1. Field of the Invention

The present invention relates to the field of wireless transmitters and specifically to a cellular (cell) phone holder and transmitter combination and a method for use.

2. Brief Description of the Related Art

People use their cell phones everyday. Cell phones have made life more convenient for most people and have increased productivity in the workplace for those who are required to travel on a regular basis. Cell phones have become so common that many have become accustomed to using their cell phones and have incorporated the use of their cell phones into their everyday life. Others have reached the point where their existence has become reliant on cell phones and without a cell phone those would lose grasp on their business and personal well being.

Talking on cell phone however can be distracting to others as well as to the person using the cell phone. It requires concentration and also requires the use of one of a person's two hands. The current method of using a cell phone while driving whereby one hand is used for holding the cell phone to an ear causes a risk to public safety. A user must take a precious hand away from the steering wheel and use it for holding the cell phone. This risk to public safety has caused many ordinances to enact laws prohibiting users of cell phones from driving while talking on their cell phones if doing so prevents both hands from being on the steering wheel.

The present invention relates to a cell phone holder transmitter and a method of use that solves the above mentioned problems.

The present invention is compact in size and light in weight whereby a holder for a cell phone is capable of being secured onto the holder attachment. The invention includes the holder, and the holder attachment. This attachment consists of a mount, a gooseneck, and a clip. The clip wedges securely into the space between the dashboard and the windshield, in the front left corner, on the vehicle's driver side (if in the countries such as Britain and Japan where the driver's seat is on the right side of the vehicle, the device may be mounted on the front right corner next to the driver). It can also be mounted on the passenger's side or any place that the clip can be wedged into. The gooseneck extends from the mount into a position determined by the driver. A clip attached onto the end of the gooseneck enables users to secure the holder into a convenient and safe position. The holder of the cell phone also acts as the transmitter thereby minimizing the size and overall dimension of the present invention. The holder's compact size allows drivers to easily carry the portable wireless transmitter. The holder comes with a detachable clip, which allows users to clip the holder and cell phone onto a variety of objects such as, but not limited to, articles of clothing, or clothing accessories, sun visor, and other surface of the dashboard where it is feasible.

The present invention in addition to being capable of transmitting from a cell phone is also capable of transmitting from an MP3 device such as by way of example and not limitation, an I-Pod, or other media player and is also compatible with other devices utilizing a 3.5 mm output audio jack.

The present invention incorporates a holder arm composed of silicon rubber embedded in the holder. Said combination of materials allow the formation of a secure seal for a cell phone while resting within the present invention and said combination additionally allows a user to place and remove a cell phone of varying dimensions with minimum effort while at the same time providing a secure placement for a cellular phone or other compatible device.

A co-axial microphone wire cable of the present invention serves as a Frequency Modulation (FM) Transmitter Antenna. Said microphone wire cable antenna is composed of a copper alloy material to further its utility as an antenna. Said alloy of said antenna aids in negative feedback noise reduction. Said Transmitter sends signals to the FM band. Said FM band transmission is of a frequency at or between 88.1 and 88.9. Said present invention operates on less than 1 watt of output in compliance with the FCC rules.

A user of the new invention may simultaneously make use of both a cell phone and a portable audio device. A user may listen to audio files until a phone call is to be made or received, and at which time, the user with a touch of a button switches the transmission from the audio listening device to the cell phone whereby conversation takes place and is heard through the speakers of a vehicle.

### SUMMARY OF THE INVENTION

One of the purposes of the new invention is to offer a user hands-free operation of a cellular telephone in a motor vehicle and is unlike anything else on the market.

The invention can also offer operation in combination with an MP3 or any other listening device that utilizes an output with a 3.5 mm audio jack.

The invention may be used in a motor vehicle.

The invention may be used in a stationary environment. By way of example and not limitation, a stationary environment may be an office or conference room whereby the present invention is utilized as a speakerphone.

The present invention incorporates a holder arm coupled with pads composed of silicon rubber embedded in the holder. Said combination of materials allows the formation of a secure seal for a cell phone while resting within the present invention and said combination additionally allows a user to place and remove a cell phone of varying dimensions with minimum effort while at the same time providing a secure placement for a cellular phone or other compatible device.

The present invention offers all of the above utilities combined into one compact unit. Other products similar in dimension only serve as a cell phone holder, and do not offer the combination as in the new invention. There has been no device on the market that has been capable of offering the combination of an integrated portable holder and wireless transmitter, that solves past deficiencies of poor transmissions, until now.

A user of the new invention may simultaneously make use of both a cell phone and a portable audio device. A user may listen to audio files until a phone call is to be made or received, and at which time, the user with a touch of a button switches the transmission from the audio listening device to the cell phone whereby conversation takes place and is heard through the speakers of a vehicle.

By way of example and not limitation, a portable audio device may be an I-Pod or other MP3 type audio listening device.

The present invention is compact in size and is small and light in weight whereby it is capable of being mounted into the space between the dashboard and windshield. The holder of the cell phone also acts as the transmitter thereby minimizing the size and overall dimension of the present invention.

The present invention is capable of transmitting from an MP3 device such as by way of example and not limitation, an I-Pod, or other media player and is also compatible with other devices utilizing a 3.5 mm output audio jack.

A microphone wire cable of the present invention serves as a Frequency Modulation (FM) transmitter antenna. Said microphone wire cable antenna is composed of a copper alloy material to further its utility as an antenna. Said alloy of said antenna aids to negative feedback noise reduction. Said Transmitter sends signals to the FM band. Said FM band transmission is of a frequency at or between 88.1 and 88.9. Said present invention operates on less than 1 watt of output. Said transmission is reproduced in stereo and/or mono.

In accordance with a preferred embodiment of the invention, there is disclosed a Cell Phone Holder and Transmitter comprising: a holder (1) coupled to retractable and expandable holder arms (2) comprising holder arm pads (3) cradle pad (8) that secure a cell phone, mp3 player or other transmitting device in place. Holder (1) is secured to the dashboard by using the attachment device which consists of mounting clips (9), and a gooseneck (10) which has a fixed clip at the end which can be inserted into the gap between the dashboard panel and the windshield panel of the vehicle.

Power is controlled on or off by means of a power switch (11) and is powered by means of battery cells located within the holder's battery bay (13). Mode is selected by means of a mode switch (4) with indicator (5) denoting whether transmitter is in audio transmission mode or in cell phone mode. Audio signals are received either through the microphone clip (7) through microphone transmitter and antenna (6) or via 3.5 mm jack (12). Audio signals are then transmitted via microphone transmitter antenna to a nearby receiver whereby voice is amplified by the FM stereo receiver in the vehicle at a frequency at or between 88.1 and 88.9 in compliance with the FCC rules.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

FIG. 1 shows the front, right and bottom perspective view of the present invention.

FIG. 2 shows a right side view of the present holder.

FIG. 3 shows a front side view of the present holder.

FIG. 4 shows a left side view of the present holder.

FIG. 5 shows a backside view thereof.

FIG. 6 shows a top view of the present holder.

FIG. 7 is a bottom view thereof.

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures.

In accordance with a preferred embodiment of the invention, there is disclosed a Cell Phone Holder and Transmitter and a method for using the same. The present invention comprising: a holder (1) coupled to retractable and expandable holder arms (2) comprising of holder arm pads (3) and cradle pad (8) that secure a cell phone, mp3 player or other transmitting device in place. The holder arms release (14) is to release the holder arms and to adjust the holder arms according to the size of the cell phone, mp3 play or other transmitting devices. Holder (1) is secured to the attachment by a mounting clip (9) and a gooseneck (10) with a fixed clip at the end.

The Cell Phone Holder and Transmitter is affixed in place by a mounting devices which consists of a mounting clip (9) and a gooseneck (10) with a fixed clip at the end, which can in inserted into the gap between the dashboard panel and the windshield panel. The ideal position of the Cell Phone Holder and Transmitter in a vehicle is the left-hand side of the driver above the left air outlet (in the countries where the drivers' seats are on the right hand side of the vehicles, the ideal position is the right-hand side of the driver above the right air outlet). This position is the least intrusive position which will not interfere with driver with any of his vehicle operations.

Power is controlled on or off by means of a power switch and FM frequency selection (11) and is powered by means of battery cells located within the holder's battery bay (13). Mode is selected by means of a mold switch (4) with indicator (5) denoting whether transmitter is in audio transmission mode or in cell phone mode. Audio signals are received either through the microphone clip (7) or via 3.5 mm jack (12). Audio signals are then transmitted via microphone transmitter antenna (6) to a nearby receiver whereby voice is amplified by speakers at a frequency at or between 88.1 and 88.9.

Any Radio Frequency (RF) source needs an antenna. The present invention utilizes a microphone transmitter antenna (6) as an external antenna. The transmission efficiency is increased via use of the external microphone transmitter antenna (6) and without increasing the overall output wattage. The signal strength at the receiver end is increased via the external microphone transmitter antenna (6). Said external antenna (6) is comprised of wiring with a length inversely proportional to wavelengths meeting maximum efficiency at frequency ranges at or between 88.1 and 88.9.

The internal circuits are modified to serve several purposes. A purpose of the modified circuits results in corresponding impedance values compatible with the selected frequencies at or between 88.1 and 88.9.

A microphone as used in other products in the market may pick up audio signals from nearby stereo speakers thereby leading to positive feedback which may result in echoes or other noises. By utilizing an external microphone transmitter antenna (6) as in the present invention, a negative feedback circuit is partially canceled out and feedback into a receiver or stereo system is eliminated.

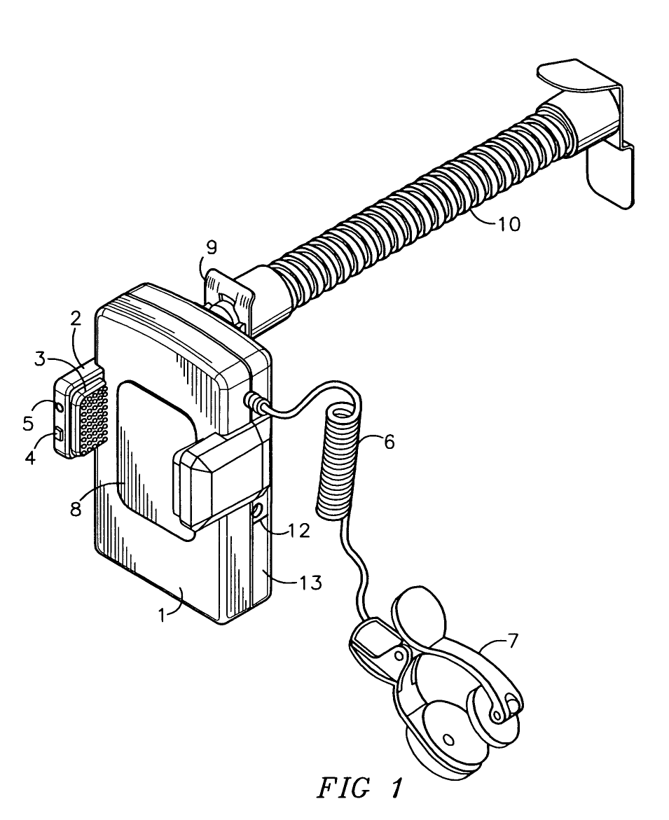

FIG. 1 is a front, right and bottom perspective view of the present invention detailing the holder (1) and retractable and expandable holder arms (2) on both sides with holder arms pads (3) composed of silicon rubber embedded in fluoride and a cradle pad (8) that secure a cell phone, mp3 player or other transmitting device in place. Holder (1) is secured to the gooseneck (10) with a fixed clip at the end by a mounting clip (9). Power is controlled on or off by means of a switch and is powered by means of battery cells located in the holder's battery bay (13). Mode is selected by means of a mode switch (4) with indicator (5) denoting whether transmitter is in audio transmission mode or in cell phone mode. Audio signals are received either through the microphone clip (7) or via 3.5 mm jack (12). Audio signals are then transmitted via microphone transmitter antenna (6) to a nearby receiver whereby voice is amplified by speakers at a frequency at or between 88.1 and 88.9.

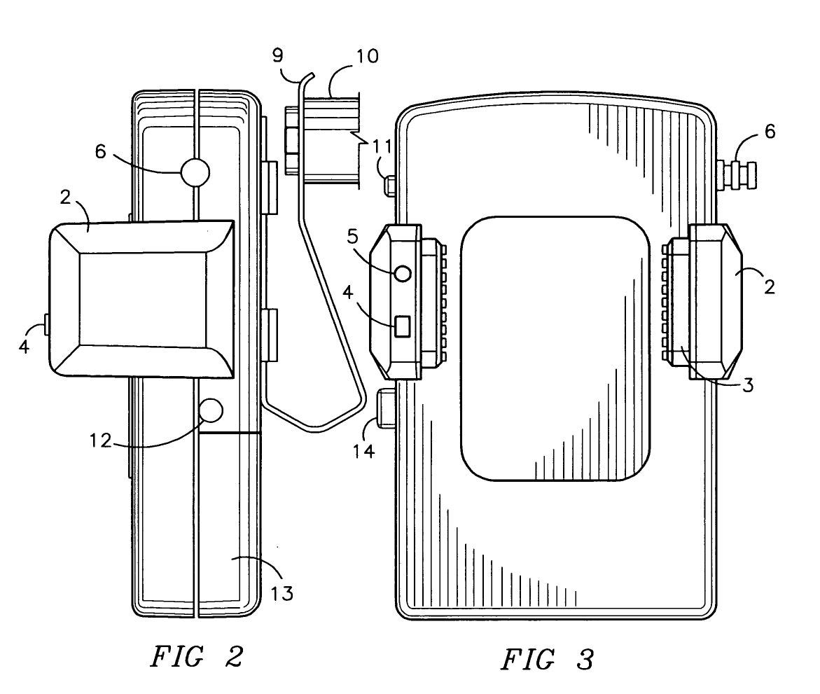

FIG. 2 is a right side view of the present invention outlining the details of the holder arm (2) used in preventing slipping of cellular phone, mp3 play or other transmitting device, the mode switch (4), the battery bay (13), the 3.5 mm jack (12) and the microphone transmitter and antenna (6) used for inputting audio from a cellular phone, mp3 player or other transmitting device, and the mounting clip (9) which affixed the Holder with the gooseneck (10).

FIG. 3 is a front view of the present invention detailing the holder (1), with coupled holder arms (2) and holder arm pads (3) and cradle pad (9) for securing a cellular phone, mp3 player or other transmitting device snugly in place; said cellular phone, mp3 player or other transmitting device is released by a holder arms release button (14); mode switch (4) and corresponding mode indicator (5); the microphone transmitter and antenna (6) used for inputting audio from a cellular phone, mp3 player or other transmitting device, and power is controlled by a power switch & FM frequency selector (11).

FIG. 4 is a left side view of the present invention outlining the details of the a holder arm (2), a mode switch (4), a holder arms release button (14), a power switch & FM frequency selector (11), and the mounting clip (9) which connects the gooseneck (10) and the holder (1).

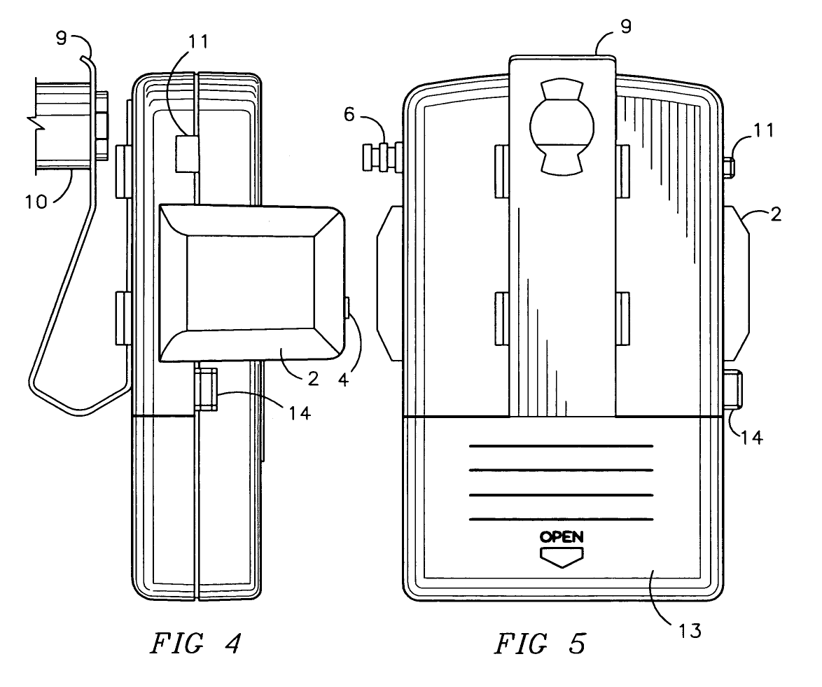

FIG. 5 is a rear view of the present invention outlining the details of the battery bay (13) and a detachable mounting clip (9), holder arms release button (14) holder arm (2), the microphone transmitter and antenna (6) used for inputting audio from a cellular phone, mp3 player or other transmitting device, and a power switch & FM frequency selector (11).

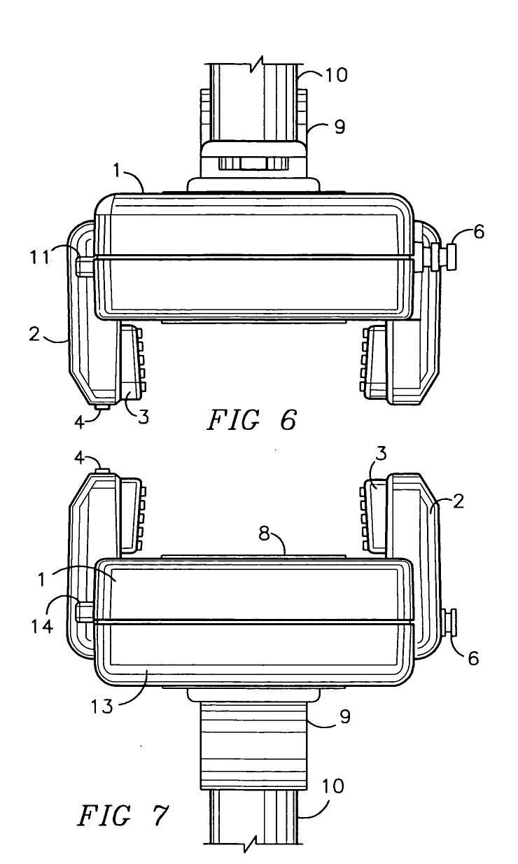

FIG. 6 is a top view of the present invention outlining the details of the holder arms (2) and holder arm pads (3), the mode switch, the power switch & FM frequency selector (11), a mounting clip (9) and a gooseneck (10) affixed on the mounting clip (9), and a microphone transmitter antenna (6).

FIG. 7 is a bottom view of the present invention outlining the details of the holder (1), the holder arms (2) and holder arm pads (3), a mounting clip (9) and a gooseneck (10) affixed on the mounting clip (9), the mode switch (4), battery bay (13), a cradle pad (8), a clip (9) and the holder arm release button (14) for placement of cellular phone, mp3 player or other transmitting device, and a microphone transmitter antenna (6).

Still other objects, features, and attendant advantages of the present invention will become apparent to those skilled in the art from a reading of the following detailed description of embodiments constructed in accordance therewith, taken in conjunction with the accompanying drawings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

What is claimed is:

1. An integrated portable wireless transmitter comprising:
a holder portion;
a transmitter portion;
an antenna portion;
a microphone portion;
a holder attachment portion;
whereby a lightweight and compact device offering a combination holder and wireless transmitter is provided

2. The invention according to claim 1, wherein the holder portion is coupled to said transmitter portion.

3. The invention according to claim 2, wherein said transmitter portion is coupled to said antenna portion.

4. The invention according to claim 3, wherein said antenna portion is coupled to said microphone portion.

5. The invention according to claim 4, wherein said holder is coupled to a plurality of arms composed of silicon rubber embedded in the holder.

6. The invention according to claim 5 wherein said silicon rubber embedded in fluoride forms a secure seal for a cell phone while resting within the present invention and said combination additionally allows a user to place and remove a cell phone of varying dimensions with minimum effort.

7. The invention according to claim 5 wherein said silicon rubber embedded in the holder forms a secure seal for an mp3 player or other transmitting device while resting within the present invention and said combination provides secure placement as well as ease of removal.

8. The invention according to claim 7, wherein said antenna also serves as a microphone wire cable serving as a Frequency Modulation (FM) transmitter antenna.

9. The invention according to claim 8, wherein said microphone wire cable antenna is composed of a copper alloy material effective in aiding furthering utility as an antenna.

10. The invention according to claim 9, wherein said alloy of said antenna and microphone wire aids negative feedback noise reduction.

11. The invention according to claim 10, wherein said transmitter sends signals to a frequency in the Frequency Modulation (FM) band.

12. The invention according to claim 11, wherein said signals in the FM band are sent to a frequency at a range at or between 88.1 and 88.9.

13. The invention according to claim 12, wherein said external antenna is selected with a length inversely proportional to wavelengths meeting maximum efficiency at frequency ranges at or between 88.1 and 88.9.

14. The invention according to claim 13, wherein said invention operates on less than 1 watt of output.

15. The invention according to claim 14, wherein said transmission is reproduced in stereo.

16. A method for using an integrated portable wireless transmitter comprising the steps of:
(a) mounting a portable wireless holder transmitter onto vehicle interior;
(b) placing a cellular phone, mp3 play or other transmitting device into said holder transmitter;
(b) clipping audio pickup microphone onto said cellular phone, mp3 play or other transmitting device;
(c) switching on transmitter;
(d) switching transmitter to cell phone mode;
(e) tuning vehicle radio receiver to a frequency on the FM band at a range at or between 88.1 and 88.9.
(f) dialing an intended receiver's telephone number designation;
(g) speaking into cell phone;
(h) listening to other voice through vehicle speakers;
(i) adjusting volume of speakers to a comfortable listening and speaking volume.
(j) canceling audio feedback through speakers with phase manipulation;

17. A method for using an integrated portable wireless transmitter comprising the steps of:
(a) connecting a portable audio device such as an I-Pod, MP3 player or other portable audio device into said portable wireless transmitter;
(b) switching on said portable audio device;
(c) switching said portable wireless transmitter to audio mode;
(d) tuning vehicle radio receiver to a frequency on the FM band at a range at or between 88.1 and 88.9.
(e) selecting favorite song or songs from said portable audio device;
(f) playing music in a vehicle, office, home, party, etc.

18. A method for using an integrated portable wireless transmitter comprising the steps of:
(a) connecting a portable audio device such as an I-Pod, MP3 player or other portable audio device to said portable wireless transmitter via a 3.5 mm. audio jack;
(b) switching on said portable audio device;
(c) switching on said portable wireless transmitter;
(d) switching said portable wireless transmitter to audio mode;
(e) tuning vehicle radio receiver to a frequency on the FM band at a range at or between 88.1 and 88.9.
(f) selecting favorite song or songs
(f) playing music in a vehicle, office, home, or at a party, etc.

19. The invention according to claim 1, wherein the holder portion is coupled to said holder attachment portion.

20. The invention according to claim 19, wherein said holder attachment comprises of a mounting clip, gooseneck with an affixed clip at the end.

21. The invention according to claim 20, wherein said holder is securely attaches into the space between the dashboard and windshield by insert the affixed clip in the gap between the dashboard panel and the windshield panel, within the vehicle's interior, on the front left corner of the vehicle.

22. The invention according to claim 21, wherein said holder attachment allows the user to position the holder and cell phone in a safe and convenient position with the least intrusion to the driver's operation of the vehicle.
